(19) United States
(12) Patent Application Publication
(10) Pub. No.: US 2004/0252830 A1
(43) Pub. Date: Dec. 16, 2004

(54) Mediated RSA cryptographic method and system

(75) Inventors: Liqun Chen, Bristol (GB); Keith Alexander Harrison, Woodcroft Chepstow (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/868,743

(22) Filed: Jun. 14, 2004

(30) Foreign Application Priority Data
Jun. 13, 2003 (GB) 0313663.7

(51) Int. Cl. H04L 9/00

(52) U.S. Cl. 380/30

(57) ABSTRACT

A mediated RSA cryptographic method and system is provided in which a sender encrypts a message using an encryption exponent e and a public modulus n, and a recipient and a trusted authority cooperate with each other to decrypt the encrypted message by using respective components d_{U}, d_{T} of a decryption exponent. In order to prevent the trusted authority from reading the message in the event that it has access to the recipient decryption exponent components d_{U}, the recipient blinds the encrypted message before passing it to the trusted authority. This blinding is effected by a modulo-n blinding operation using a factor r^{e} where r is a secret random number. The trusted authority then applies its decryption exponent component d_{T} to the message and returns the result to the recipient who cancels the blinding and applies its decryption exponent component d_{U}.

### FIELD OF THE INVENTION

The present invention relates to a mediated cryptographic method and system.

### BACKGROUND OF THE INVENTION

The RSA public key cryptographic method is well known and in its basic form is a two-party method in which a first party generates a public/private key pair and a second party uses the first party's public key to encrypt messages for sending to the first party, the latter then using its private key to decrypt the messages. More particularly, and with reference to FIG. 1 of the accompanying drawings, in the basic RSA encryption method the following operational steps are carried out by a message sender A and a message recipient B acting through respective computing entities 10 and 20:

Initial Set Up Phase

1. B chooses distinct random primes p and q.

2. B computes n=(p).(q) and φ=(p−1).(q−1).

3. B selects an encryption exponent e such that e and φ have no common factors.

4. B computes a decryption exponent d=1/e mod φ.

5. B publishes both e and n as its public key and keeps d secret as its private key (p, q and φ are either destroyed or also kept secret)

Message Transfer Phase

6. A generates a message m.

7. A computes m^{e} mod n and sends this to B.

8. B computes (m^{e})^{d} mod n to recover m.

The set up phase is carried out once whilst the message transfer phase is carried out for each message to be sent from A to B. In practice, the set up phase may be carried out on behalf of B by a certificate authority that provides a trustable certificate associating B to its public key <e,n> and communicates d securely to B; the value of e is fixed for any particular domain.

It is often required to provide for control of message sending from A to B using a particular key pair. For example, A and B may initially be members of the same organisation with A sending messages to B using a public key for B that was certified or otherwise vouched for by the organisation as being associated with B; however, should B leave the organisation, it is desirable that the validity of B's public key be immediately revoked. One way of doing this is by the use of a revocation list that A must check each time it wants to send a message. A more reliable method is to use a mediated RSA method in which the decryption exponent d is split into two components, one held by B and the other held by a security mediator; in this case, both decryption exponent components must be applied to an encrypted message to decrypt it. This means that the security mediator must be contacted by B each time B wishes to decrypt a new encrypted message from A; the security mediator thus has control over which messages B decrypts and can therefore implement any desired control policy including, in the present example, preventing B decrypting messages after B has left the organisation.

However, it will generally be undesirable for the security mediator to have the ability to fully decrypt messages sent to B which implies that the security mediator must not have knowledge of B's decryption exponent component (or the data needed to compute it). Therefore, the security mediator must be separate from the entity generating the two decryption exponent components; since this latter entity clearly cannot be B (as B would then not need to go to the security mediator to decrypt a message), a separate key generation entity is needed with the result that most mediated RSA methods are four-party methods.

FIG. 2 of the accompanying drawings depicts the operational steps carried out in a four-party mediated RSA method, the parties involved being a message sender A, a message recipient B, a security mediator SEM and a key generation center KGC each acting through a respective computing entity 10, 20, 30 and 40. The operational steps involved are:

Initial Set Up Phase

For each B, the KGC carries out steps 1 to 8

1. KGC chooses distinct random primes p and q.

2. KGC computes n_{B}=(p)×(q) and φ_{B}=(p−1).(q−1).

3. KGC selects an encryption exponent e (the same for all Bs) such that e and φ_{B} have no common factors.

4. KGC computes a decryption exponent d=1/e mod φ_{B}.

5. KGC chooses d_{U} (different for each B).

6. KGC computes d_{T}=(d−d_{U}) mod φ_{B}.

7. KGC securely communicates d_{T} to the security mediator SEM and d_{U} to B.

8. KGC publishes both e and n as the public key for B.

Message Transfer Phase

9. A generates a message m.

10. A computes m^{e} mod n_{B} and sends this to B which forwards it to the security mediator SEM.

11. SEM computes x=(m^{e})^{d}^{_{T}} mod n_{B} and returns it to B.

12. B receives x which is equivalent to (m^{e})^{(d-d}^{_{U}}⁾ mod n_{B}.

13. B computes x^{d}^{_{U}} mod n_{B} to recover the message m.

B's decryption exponent component d_{U} can, of course, be generated by B or jointly by the KGC and B, provided both know its value (in other words d_{U} is a shared secret of B and the KGC). Unless the security mediator SEM only serves one recipient B, the security mediator will need to be provided with a recipient identifier in order to able to select which d_{T} and n_{B} to use in step 11. This recipient identifier can be one provided by the party passing it the encrypted message since it is not necessary for the security mediator to trust the recipient identifier—if the identifier does not identify the intended recipient of the message, then the message will not be even partially decrypted by application of the d_{T} retrieved using the identifier.

An inherent positive feature of the FIG. 2 mediated RSA method is that the messages passing between B and the security mediator are encrypted. However, a drawback of the method so far as B is concerned is that although there is apparent separation of the KGC and the security mediator which should ensure that messages to B cannot be read by the security mediator, in reality there is no guarantee for B that the KGC and the security mediator are not collaborating to read B's messages.

A recently proposed variant of the mediated RSA method provides an identifier-based cryptographic method; this variant is described in the paper “Identity based encryption using mediated RSA”, D. Boneh, X. Ding and G. Tsudik, 3rd Workshop on Information Security Application, Jeju Island, Korea, August, 2002.

Identifier-Based Encryption (IBE) is an emerging cryptographic schema in which the encryption key used to encrypt a message is based on a sender-chosen string and public data, the corresponding decryption key being computed, potentially subsequent to message encryption, using the sender-chosen string and private data associated with the public data. Frequently, the sender-chosen string is a predetermined string that serves to “identify” the intended message recipient and this has given rise to the use of the label “identifier-based” or “identity-based” generally for these cryptographic methods. However, depending on the application to which such a cryptographic method is put, the sender-chosen string may serve a different purpose to that of identifying the intended recipient and, indeed, may be an arbitrary string having no other purpose than to form the basis of the encryption key. Accordingly, the use of the term “identifier-based” herein in relation to cryptographic methods and systems is to be understood simply as implying that the encryption key is based on a sender-chosen, cryptographically unconstrained, string whether or not the string serves to identify the intended recipient, and that the corresponding decryption key can be subsequently computed (though in certain applications it may be pre-computed). Furthermore, as used herein the term “string” is simply intended to imply an ordered series of bits regardless of their source.

In the identifier-based mediated RSA method described in the above-referenced paper, each potential recipient B has an associated predetermined identifier string ID_{B}, such as an email address, that identifies the recipient. Thus, there exists a set of predetermined identifier strings ID_{B} which by their nature are generally known to A and to the key generation center KGC. When A wishes to send a message to a particular recipient B, A chooses the relevant identifier string from the set of such strings and uses the chosen string to compute an encryption exponent. To effect its partial decrypt of the message, the security mediator SEM uses a decryption exponent component that the KGC has pre-computed for the recipient concerned using the known identifier string ID_{B} of that recipient. FIG. 3 of the accompanying drawings depicts in more detail the operational steps of this identifier-based mediated RSA method, these operational steps being as follows:

Initial Set Up Phase

1. KGC chooses distinct random primes p and q. The primes p and q are specific to a particular domain and are not recipient dependent.

2. KGC computes n=(p).(q) where n has a fixed value for the domain, this value being published in an appropriate certificate. KGC also computes φ=(p−1).(q−1).

For each B, the KGC carries out steps 3 to 8

3. KGC uses the identifier string ID_{B} of the particular recipient B concerned to compute a recipient-specific encryption exponent e_{B}; the function F used to compute e_{B} is typically a hash function. The exponent e and the value φ should have no common factors.

4. KGC computes a recipient-specific decryption exponent d=1/e_{B} mod φ.

5. KGC chooses d_{U} (different for each B).

6. KGC computes a recipient-specific d_{T}=(d−d_{U}) mod φ.

7. KGC securely communicates d_{T} to the security mediator SEM and d_{U} to B.

8. KGC publishes ID_{B} for B (only if not already known to message senders—where ID_{B} is B's email address, it typically would not be re-published by the KGC).

Message Transfer Phase

9. A generates a message m.

10. A chooses the identifier string ID_{B} of the intended recipient and computes the corresponding encryption exponent e_{B} using the same function F as used by the KGC (this function will have typically been incorporated in software provided to A's computing entity 10 for implementing the cryptographic method, but maybe provided to A in any suitable manner including by distribution with n).

11. A computes m^{e}^{_{B}} mod n and sends this to B which forwards it to the security mediator SEM.

12. SEM computes x=(m^{e}^{_{B}})^{d}^{_{T}} mod n and returns it to B.

13. B receives x which is equivalent to (m^{e}^{_{B}})^{(d-d}^{_{U}}⁾ mod n.

14. B computes x^{d} mod n to recover the message m.

This identifier-based mediated RSA method has the same features, positive and negative, mentioned above with respect to the mediated RSA method of FIG. 2. Like the FIG. 2 mediated RSA method, the identifier-based mediated RSA method of FIG. 3 must keep the key generation center KGC independent of the security mediator if the latter is not to have access to the messages. As a result, the identifier strings used by A must generally be predetermined strings for Which the KGC has already determined the corresponding decryption exponent component d_{T} to be used by the security mediator (the alternative of re-involving the KGC for each message to compute the d_{T} for use by the security mediator is unattractive in practical terms).

It should also be noted that the same message m must never be encrypted using two different encryption exponents as this would compromise the security of the method. As a consequence, the basic message data must normally be combined with random padding to form the message m to be sent.

It is an object of the present invention to provide improved mediated RSA cryptographic methods and systems.

### SUMMARY OF THE INVENTION

According to one aspect of the present invention, there is provided a mediated RSA cryptographic method in which a sender encrypts a message using an encryption exponent e and a public modulus n, and a recipient and a trusted authority cooperate with each other to decrypt the encrypted message by using respective components d_{U}, d_{T} of a decryption exponent; a recipient, on receiving the encrypted message, carrying out first processing comprising a modulo-n blinding operation using a factor r^{e} where r is a secret random number, the resultant processed message being passed to the trusted authority which effects second processing comprising applying its decryption exponent component d_{T} to the message, and the resultant further-processed message being returned to the recipient which effects third processing comprising both cancelling the blinding and applying its decryption exponent component d_{U}.

Blinding itself is a known technique (see, for example, “Blind signatures for untraceable payments” in Advances in Cryptology—D. Chaum, Crypto '82, pp. 199-203, Springer-Verlag, 1983); however, the present invention is based in part on the insight that application of blinding to four-party mediated RSA cryptographic methods permits these methods to become three-party in nature. More particularly, by using blinding it becomes possible to treat the key generation center and security mediator as a single entity as their separation is no longer necessary to ensure that a message is unreadable by the mediating entity.

A consequence of using blinding to prevent the trusted authority reading a message is that in identifier-based mediated RSA methods, where the sender chooses a string for which the decryption exponent component d_{T} has not been pre-computed it becomes possible for only a single entity, additional to the recipient, to be involved in the decryption process.

Whilst the method of the invention can be applied to situations where the trusted authority is set up to serve only one intended recipient, the trusted authority will typically serve multiple recipients each of which can be arranged to have its own associated decryption exponent component d_{U}; in this case, the trusted authority needs to be provided, in relation to a message passed to it for processing, with a recipient identifier which the trusted authority uses to determine the appropriate decryption exponent component d_{T} for the second processing.

In a preferred embodiment, there is provided an identifier-based cryptographic method with the encryption exponent e being made a function of a string chosen by the sender. The trusted authority will typically then be arranged to use the string to calculate, subsequent to message encryption, the decryption exponent component d_{T} appropriate for the message, the string either having been passed directly or indirectly from the sender to the trusted authority or, where the chosen string is one of a set of strings known to the trusted authority, looked up by the trusted authority on the basis of a string indicator provider from the sender. However, where the chosen string is one of a set of predetermined strings each specific to a particular intended recipient with its own value of d_{U}, the decryption exponent component d_{T} can be pre-computed for each recipient and looked-up using the recipient identifier.

Advantageously, the string chosen by the sender comprises action information concerning actions to be taken by the trusted authority, the trusted authority using the action information in the string to carry out corresponding actions. Preferably, the action information 'specifies one or more conditions to be checked by the trusted authority, the second processing including the trusted authority checking these one or more conditions and only completing the second processing if the conditions are met. Typical conditions include a recipient-identity condition, conditions concerning other attributes of the intended recipient, and conditions unrelated to the intended recipient (such as a date or time condition).

In another embodiment, the encryption exponent e is fixed and the modulus n is specific to each of multiple recipients. In this case also, the trusted authority can be arranged either to store or calculate its corresponding decryption exponent components d_{T}.

The present invention also encompasses systems, apparatus and computer program products for implementing the foregoing methods.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating the operational steps of the well-known basic RSA cryptographic method;

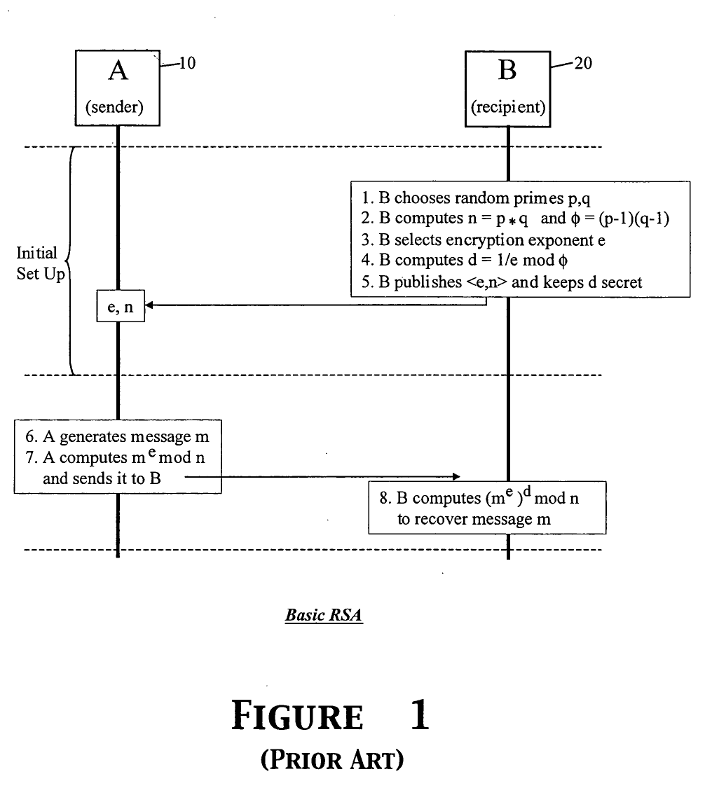

FIG. 2 is a diagram illustrating the operational steps of a prior art mediated RSA cryptographic method;

FIG. 3 is a diagram illustrating the operational steps of a prior art identifier-based mediated RSA cryptographic method;

FIG. 4 is a diagram illustrating the operational steps of a blinded, identifier-based, mediated RSA cryptographic method forming a first embodiment of the invention;

FIG. 5 is a diagram illustrating the operational steps of a blinded, identifier-based, mediated RSA cryptographic method forming a second embodiment of the invention; and

FIG. 6 is a diagram illustrating the operational steps of a blinded mediated RSA cryptographic method forming a third embodiment of the invention.

### BEST MODE OF CARRYING OUT THE INVENTION

Three embodiments of the invention are described below, the first two embodiments concerning blinded, identifier-based (IB), mediated RSA methods and systems in which the value of the encryption exponent e is varied, and the third embodiment concerning a blinded, non-IB, mediated RSA method and system in which the value of e is kept constant and the value of the modulus n is made recipient specific.

The Identifier-Based Embodiments

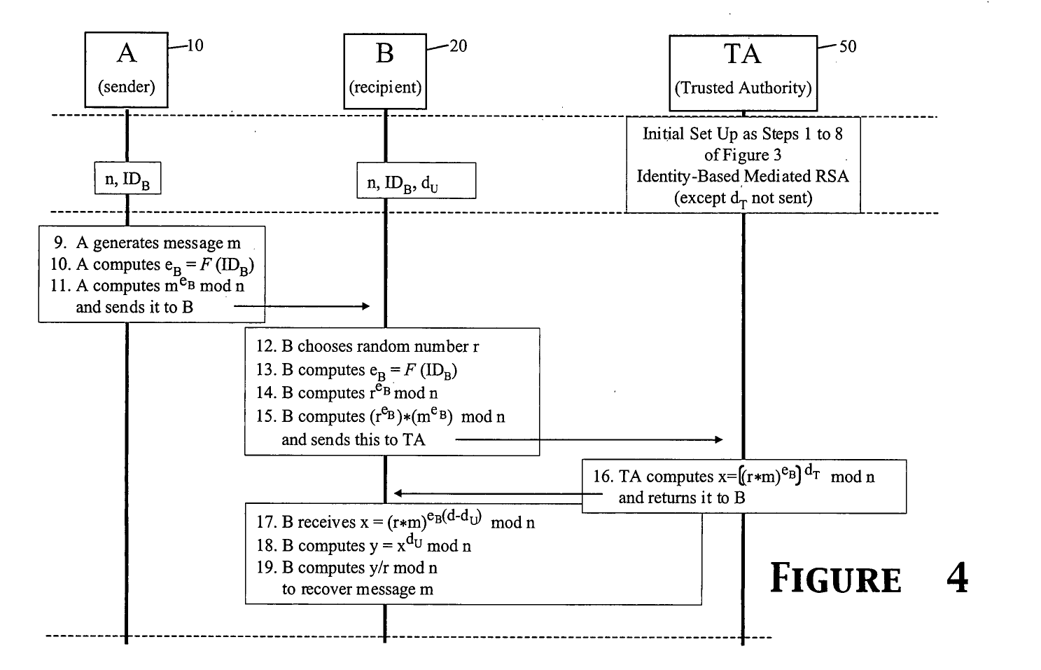

The identifier-based RSA cryptographic method and system forming the first embodiment of the invention is illustrated in FIG. 4 and involves three parties, namely a message sender A acting through computing entity 10, a message receiver B acting through computing entity 20, and a trusted authority TA acting through computing entity 50. The computing entities 10, 20 and 50 are typically based around program-controlled processors though some or all of the cryptographic functions may be implemented in dedicated hardware. The entities 10, 20 and 50 inter-communicate, for example, via the internet or other computer network though it is also possible that two or all three entities actually reside on the same computing platform. For convenience, the following description is given in terms of the parties A, B and TA, it being understood that these parties act through their respective computing entities.

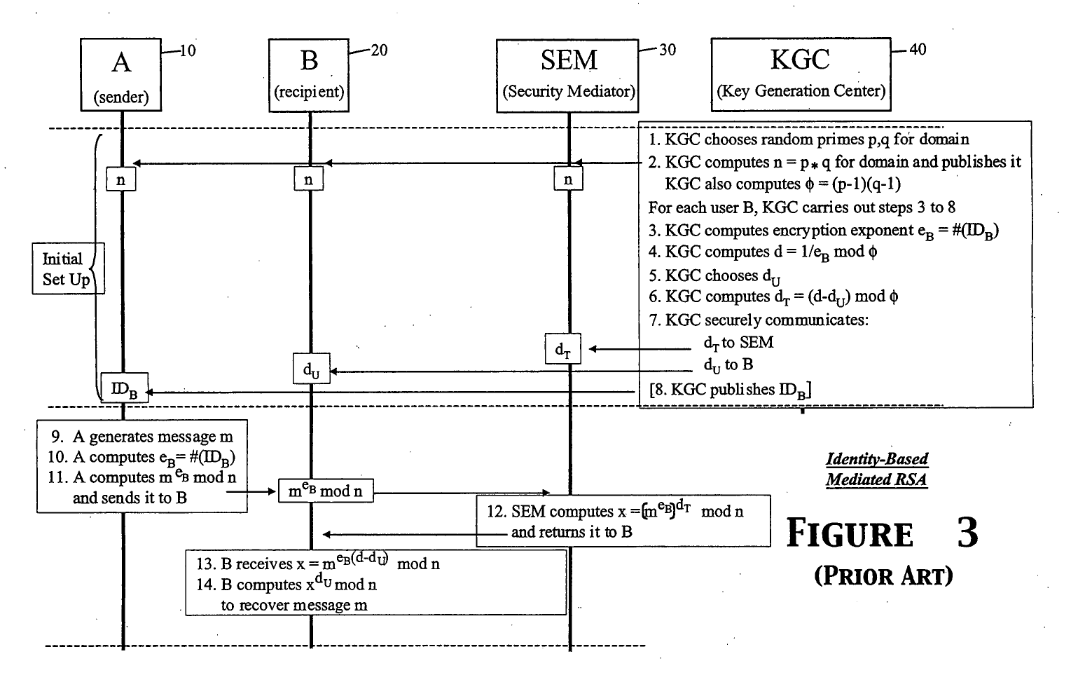

The RSA method of the first embodiment is similar to the prior art method illustrated in FIG. 3 in that a predetermined identifier string ID_{B} of the intended message recipient B is used by the message sender A to compute the encryption exponent e for encrypting a message, and pre-computed decryption exponent components d_{U} and d_{T} are used to decrypt the encrypted message. However, the key generation center KGC and security mediator SEM of the FIG. 3 arrangement are now treated as combined into the single trusted authority TA thereby giving a three-party method and system. Furthermore, in the FIG. 4 method and system, the message recipient B blinds the encrypted message before passing it to the trusted authority for the latter to apply its decryption exponent component d_{T}, the recipient B cancelling the blinding after receiving back the message processed by the trusted authority

A more detailed description of the operational steps involved in the FIG. 4 method will now be given.

Initial Set Up Phase

This is the same as for the set up phase of the above-described identifier-based mediated RSA method depicted in FIG. 3 with the trusted authority TA carrying out the same steps 1 to 8 as performed by the key generation center KGC; in particular, a domain-specific modulus n is chosen, values of d_{U} agreed, and values of d_{T} computed for each recipient identifier string ID_{B}, these various values being distributed as required. However, because the trusted authority combines the roles of the key generation center and security mediator of the FIG. 3 arrangement, there is no longer a need to securely communicate the computed values of the decryption exponent component d_{T}, these values simply being kept secret by the trusted authority; in contrast, B now also needs to be provided with the predetermined function F used to compute encryption exponents from the identifier strings ID_{B} and this can be done in the same way as the function was provided to A or in any other suitable manner.

Message Transfer Phase

Encryption of Message by A

9. A generates a message m.

10. A chooses the identifier string ID_{B} of the intended recipient and computes the corresponding encryption exponent e_{B} using the same function F as used by the trusted authority during the set up phase.

11. A computes m^{e}^{_{B}} mod n and sends this to B.

Message Blinding by B

12. B chooses a secret random number r.

13. B computes e_{B} from the identifier string ID_{B} using the same function F as used by the trusted authority during the set up phase. The identifier string ID_{B} may be passed to B by A along with the encrypted message or may be looked up by B using a recipient identifier provided by A (it being assumed that B has access to all identifier strings); alternatively, B can use its own identifier string on the basis that this will be the correct string to use if the message is intended for B (and if it isn't, use of the right or wrong string becomes irrelevant since B will not, in any event, be able to correctly decrypt the message as it does not have the correct d_{U}).

14. B computes r^{e}^{_{B}} mod n.

15. B blinds the encrypted message by computing (r^{e}^{_{B}}).(m^{e}^{_{B}}) mod n and sends this to the trusted authority TA together with a recipient identifier (such as the string ID_{B}).

Partial Decryption by the Trusted Authority TA

16. The trusted authority TA uses the received recipient identifier to look up the value of d_{T} to apply and then computes x=((r.m)^{e}^{_{B}})^{d}^{_{T}} mod n and returns x to B.

Completion of decryption and cancellation of blinding by B

17. B receives x which is equivalent to (r.m)^{e}^{_{B}}^{(d-d}^{_{U}}⁾ mod n.

18. B computes y=x^{d}^{_{U}} mod n.

19. B computes y/r mod n to recover the message m.

It will be appreciated that the blinding applied by B to the encrypted message before passing it to the trusted authority ensures that the latter cannot read the message even if it has retained B's value of d_{U} from the set up phase. The blinding, which involved a multiplication of the encrypted message by a factor r^{e}^{_{B}} mod n, is cancelled in steps 19 and 20 by a multiplication by a factor r^{(ed}^{_{U}}⁻¹⁾.

It may be noted that instead of recipient identifier strings ID_{B} being used as the basis for computing encryption exponents, any set of predetermined strings can be used with the corresponding values of d_{T} being computed during the set up phase (though now, assuming every string is potentially usable with every recipient, a respective value of d_{T} needs to be computed for every string/recipient combination as d_{T} is dependent both on the value of the string and on the value of d_{U}). In this case, the sender A chooses an appropriate one of the predetermined strings when encrypting a message and the chosen string is passed from the sender to B and to the trusted authority to enable these entities to compute the correct value of e and to permit the trusted authority to look up the correct pre-computed value of d_{T} for the string having regard to the recipient concerned. One or both of the message recipient B and trusted authority can be arranged to store the set of predetermined strings and to retrieve the appropriate string from its store using a string indicator supplied to it in place of the string itself. The string indicator will generally have been initially provided by the sender A along with the encrypted message. It may also be noted that whilst the sender A could pass on the value of e for use by the other entities, the trusted authority should not rely on a value of e passed to it but should always compute e from the predetermined string used (this ensures that the sender has not chosen a specific value of e to gain cryptographic insights into private key data).

As already mentioned above, applying blinding to the encrypted message passed to the trusted authority, ensures that the latter cannot read the message. As a consequence, the trusted authority can be allowed to retain d_{U} after having used it in the set up phase to compute corresponding values of d_{T} for the predetermined strings. This opens up the possibility of the computation of the values of d_{T} being carried out after the set up phase; in particular, the computation of a value of d_{T} can now be deferred until the time it is needed for use in decrypting a message. In turn, this gives rise to the significant advantage that the string used as the basis for the encryption key no longer needs to be a predetermined string but can be any string that the sender chooses to use, provided the string used is made known to the trusted authority.

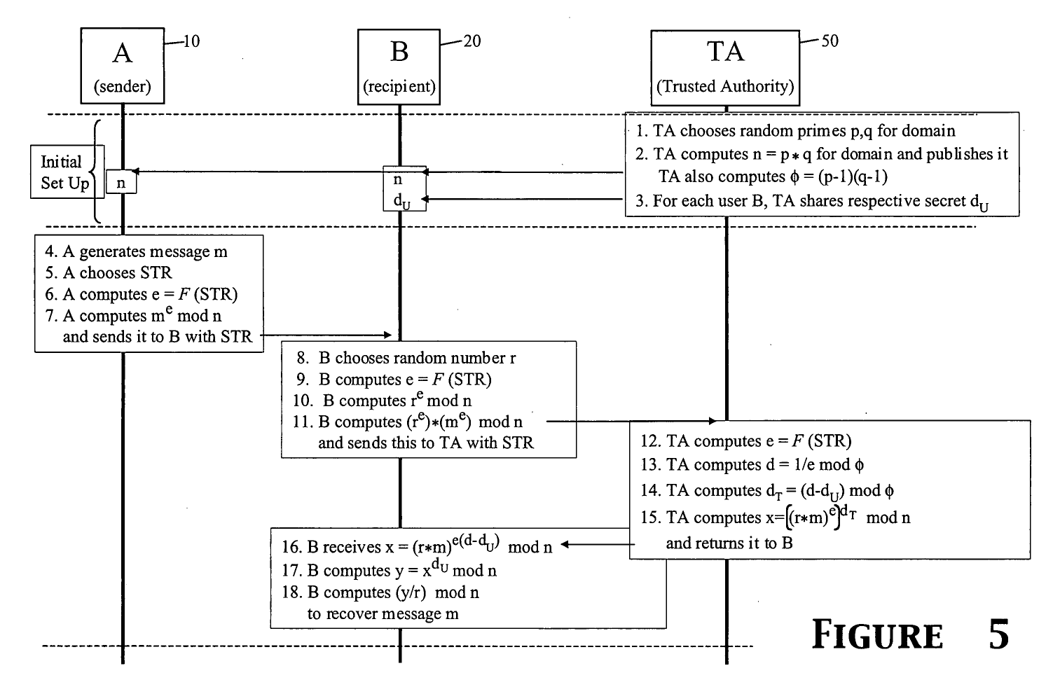

The second embodiment of the invention, which is illustrated in FIG. 5, provides an identifier-based mediated RSA method in which the string chosen by A as the basis for the encryption exponent can be any string as the corresponding value of d_{T} for any particular recipient is subsequently computed by the trusted authority. More particularly, the operational steps of the second embodiment are as follows:

Initial Set Up Phase

1. The trusted authority TA chooses distinct random primes p=2p′+1 and q=2q′+1 where both p′ and q′ are Sophie Germain primes. The primes p and q are specific to a particular domain/application/trusted-authority and are not recipient dependent.

2. TA computes n=(p).(q) where n has a fixed value for the domain, this value being published in an appropriate certificate. TA also computes φ=(p−1).(q−1).

3. For each B, the TA and B share a secret d_{U} generated by one or other party or jointly.

Message Transfer Phase

Encryption of Message by A

4. A generates a message m.

5. A chooses a string STR—this may be any string subject to any restrictions imposed, for example, by a particular application or by the trusted authority.

6. A applies the predetermined function F to the string STR to compute a corresponding encryption exponent e, the function being such that e is odd.

7. A computes m^{e} mod n and sends this to B along with the string STR.

Message Blinding by B

8. B chooses a secret random number r.

9. B computes e from the string STR using the predetermined function F.

10. B computes r^{e} mod n.

11. B computes (r^{e}).(m^{e}) mod n and sends this to the trusted authority TA together with the string STR and a recipient identifier.

Partial Decryption by the Trusted Authority TA

12. B computes e from the string STR using the predetermined function F.

13. TA computes decryption exponent d=1/e mod φ.

14. TA computes d_{T}=(d−d_{U}) mod φ.

15. TA then computes x=((r.m)^{e})^{d}^{_{T}} mod n and returns x to B.

Completion of Decryption and Cancellation of Blinding by B

16. B receives x which is equivalent to (r.m)^{e(d-d}^{_{U}}⁾ mod n.

17. B computes y=x^{d}^{_{U}} mod n.

18. B computes y/r mod n to recover the message m.

The FIG. 5 blinded, identifier-based, mediated RSA method thus ensures that the trusted authority cannot read the message m whilst guaranteeing its involvement in message decryption. In addition, any string STR can be used and the trusted authority is not required to store any data other than the values of p and q (and/or their derivatives n and φ) and the or each value of d_{U}.

As regards the string STR chosen by the sender, as already indicated, this string may be any string. The string can be based on a character string, a serialised image bit map, a digitised sound, or any other data including data input by the sender using any suitable input device such as a keyboard or keypad. However, in many cases restrictions will be placed on the strings selectable by the sender. For example, the string may be required to conform to a predetermined set of rules with regard to its formatting and/or content (e.g. the string STR may be required to comply with a particular XML schema); alternatively, the sender may be required to select a string from a set of predetermined strings provided by the trusted authority or by another party. In this latter case, the predetermined set of strings can be stored by the trusted authority and/or B and retrieved against a string indicator provider by the sender A, the retrieved string then being used in the computation of e.

Generally (though not necessarily), the string STR is used to convey to the trusted authority information concerning actions to be taken by the trusted authority when it receives the encrypted message for decryption. If a recipient B changes the information in the string before passing it to the trusted authority, the string will no longer be usable to compute the correct decryption exponent d_{T} in steps 12 to 14 of FIG. 5.

The information in the string STR may relate to actions to be taken by the trusted authority that do not affect message decryption—for example, the trusted authority TA may be required to send a message to the message sender A at the time the TA decrypts the message concerned. However, the information in the string STR will frequently specify one or more conditions to be checked by the trusted authority as being satisfied before the trusted authority partially decrypts the related encrypted message (or before returning the corresponding partially decrypted message to the recipient B concerned).

For example, the string STR may comprise a recipient identity condition identifying a specific intended message recipient; in this case, the trusted authority carries out an authentication process with the recipient B presenting the related message for decryption to check that the recipient concerned meets the recipient-identity condition.

Rather than identifying an intended recipient as a particular individual, the string STR may comprise one or more conditions specifying one or more non-identity attributes that the recipient must possess; for example, a condition may specify that a recipient must have a certain credit rating. Again, it is the responsibility of the trusted authority to check out this condition before producing the decrypted message for a recipient presenting the encrypted message for decryption.

The string STR may additionally or alternatively comprise one or more conditions unrelated to an attribute of the intended recipient; for example, a condition may be included that the message concerned is not to be decrypted before a particular date or time.

Whatever the conditions relate to, the string STR may directly set out the or each condition or may comprises one or more condition identifiers specifying corresponding predetermined condition known to the trusted authority (in the latter case, the trusted authority uses the or each condition identifier to look up the corresponding condition to be checked).

In the FIG. 5 embodiment, the value of the public modulus n and of the corresponding private data p,q (or φ) held by the trusted authority is assumed to be fixed for the domain/application/trusted-authority concerned. However, it is possible for multiple different values of the modulus n and the corresponding private data to be in use together. For example, there may be multiple groups of recipients each of which has associated value of n and of the corresponding private data. In the extreme, each recipient B has its own associated values of n and p,q (or φ). Of course, where there are multiple values of n and p,q (or φ) in use, the trusted authority needs to be provided with an indication of the values to be used for any particular message; for example, a group or recipient indicator can be included in the string STR or provided by the recipient B presenting the encrypted message for decryption.

Non IB Embodiment

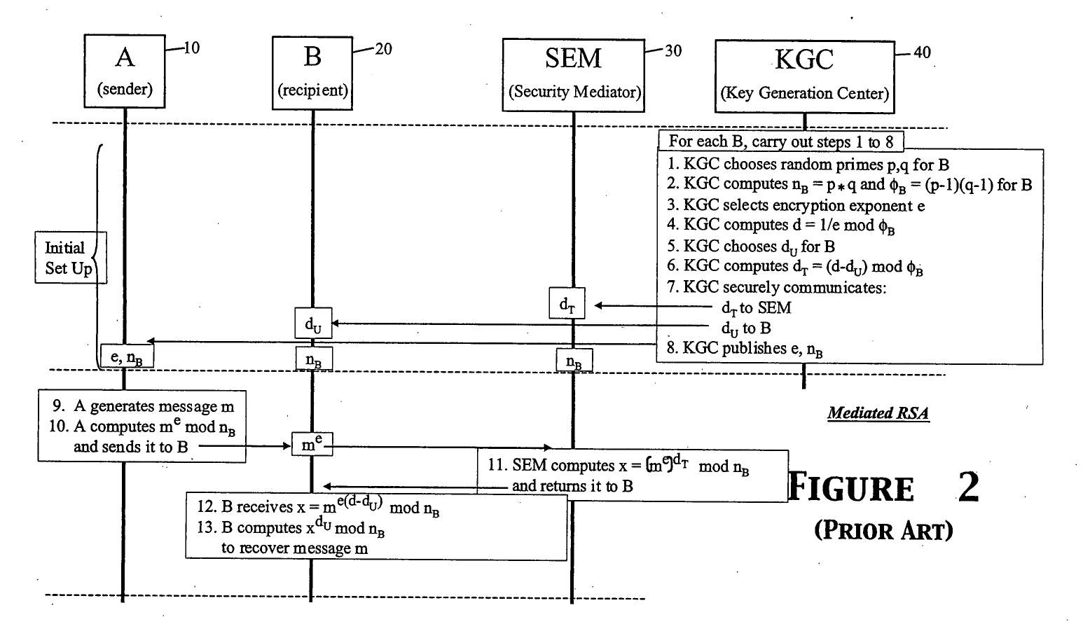

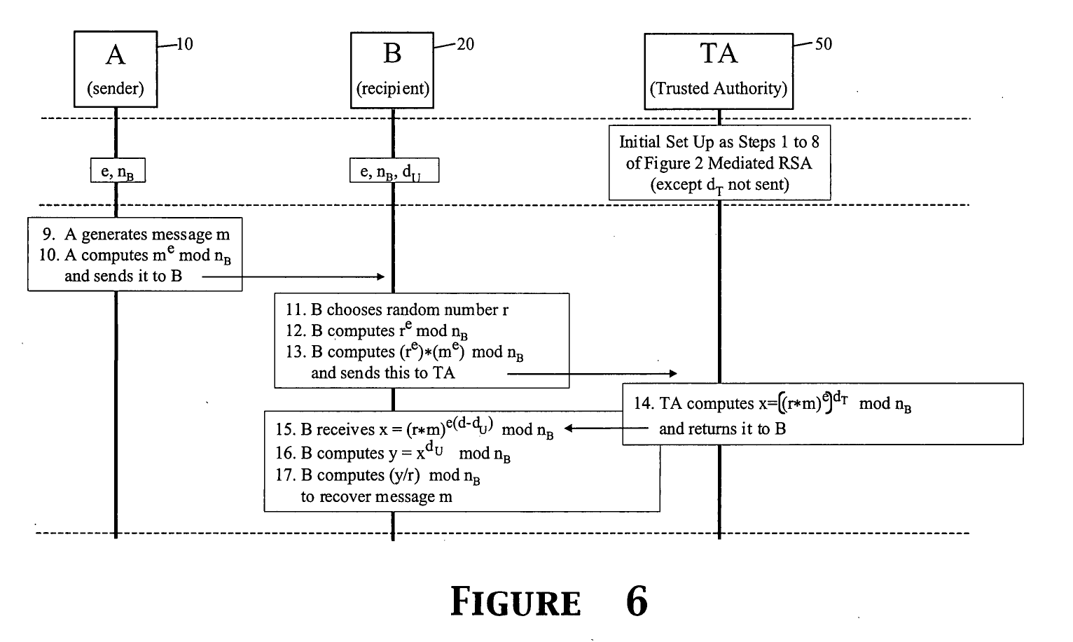

The third embodiment depicted in FIG. 6 concerns a blinded, non-IB, mediated RSA method and system in which the value of e is kept constant and the value of the modulus n is made recipient specific; this embodiment thus has similarities with the prior art four-party mediated RSA method of FIG. 2. However, the FIG. 6 embodiment is a three-party method combining the key generation center and security mediator of FIG. 2 into a single trusted authority entity. The operational steps of the third embodiment are as follows:

Initial Set Up Phase

This is the same as for the set up phase of the prior art mediated RSA method depicted in FIG. 2 with the trusted authority TA carrying out the steps 1 to 8 performed by the key generation center KGC (with the result that no communication of d_{T} is required). B is now also provided with the encryption exponent e.

Message Transfer Phase

Encryption of Message by A

9. A generates a message m.

10. A computes m^{e} mod n_{B} and sends this to B.

Message Blinding by B

11. B chooses a secret random number r.

12. B computes r^{e} mod n_{B} using it's own value of n_{B}.

13. B computes (r^{e}).(m^{e}) mod n_{B} again using it's own value of n_{B} and sends the result to the trusted authority TA together with a recipient identifier (such as n_{B}).

Partial Decryption by the Trusted Authority TA

14. The trusted authority TA uses the received recipient identifier to look up the value of d_{T} (and n_{B} if not supplied) to use and computes x=((r.m)^{e})^{d}^{_{T}} mod n; TA then returns the computed value of x to B.

Completion of Decryption and Cancellation of Blinding by B

15. B receives x which is equivalent to (r.m)^{e(d-d}^{_{U}}⁾ mod n_{B}.

16. B computes y=x^{d}^{_{U}} mod n_{B}.

17. B computes y/r mod n_{B} to recover the message m.

Again, because of the blinding applied by B, the trusted authority is unable to read the message presented to it by B.

General

As is the case with all mediated RSA methods, in the embodiments of the invention described herein, the trusted authority TA will typically perform a control function (over and above that associated with implementing any conditions contained in the string STR) for ensuring that the recipient B presenting the trusted authority with a message for partial decryption, is only serviced if entitled to receive such a service; thus, for example, the trusted authority can provide for immediate implementation of a revocation list.

It may be noted that a consequence of the recipient B applying blinding to the encrypted message sent to the trusted authority is that it is no longer essential for the recipient's decryption exponent component d_{U} to be kept secret to ensure that a third party cannot read the message. However, keeping d_{U} secret has the benefit of ensuring that only the intended recipient can correctly decrypt the message thereby relieving the trusted authority of the need to check that the recipient B presenting it with the encrypted message corresponds to an intended recipient (as may have been indicated to the trusted authority, for example, in the string STR in the case of the FIG. 5 embodiment).

As is well known, in RSA methods the encryption exponent e must have no common factors with (p−1).(q−1). This can be checked by the trusted authority where e is known in advance to the trusted authority; however, in the identifier-based mediated RSA embodiments of the invention e may not be known to the trusted authority in advance of its use—for example, in the FIG. 5 embodiment the encryption exponent e may be based on a string created by the sender. In order to meet the requirement that the encryption exponent e have no common factors with (p−1).(q−1), where the trusted authority does not know e in advance, the following constraints (already stated in the description of the FIG. 5 embodiment) can be imposed:

the function F used to generate the encryption exponent is such that e is always odd; and

p=(2p′+1) and q=(2q′+1) where p′ and q′ are Sophie Germain primes.

These constraints together serve to ensure, with a very high probability, that the encryption exponent e and (p−1).(q−1) will have no common factors.

Whilst the above-described embodiments are adequate in some environments, for most environments certain constraints need to be applied to remove their vulnerability to a number of attacks.

Traffic Analysis: If the same encrypted message is seen twice, then it is likely that it is the same message being encrypted with the same key and transmitted. This gives information to the attacker. The cure is to use random padding to ensure that the same message is never encrypted twice. The basic message content is thus combined with random padding and a message-content length indicator to form the message m to be encrypted.

Active Attacker: In the described embodiments, B passes (r.m)^{e} mod n to the trusted authority. A third party intercepting this message could compute:

(newm^{e}/m^{e}).(r.m)^{e} mod n=(r.newm^{e}) mod n

thus changing the message m to newm. The channel between B and TA should therefore be able to detect any attempt to modify the message.

Common Modulus Attack: With RSA methods it is accepted that one should never encrypt the same message multiple times with different exponents that are coprime, since an attacker could then use the Extended Euclidean Algorithm to recover the original message. The embodiments of FIGS. 4 and 5 are vulnerable to this attack; however, various solutions are available:

Use random padding of the message, as described above, to ensure that the same message is never encrypted twice.

Ensure that the same message content is never re-sent—whilst this is possible to do in theory (for example, by storing all sent messages and checking any new message against the stored messages) in reality this solution is only practical in limited situations.

Ensure that the exponents are never coprime (that is, values of e derived from different strings having a common divisor greater than one). This can be achieved, for example, by making all exponents a multiple of 3; thus e can be derived from the string STR using a hash function # for which #(STR)≡3 mod 6—in other words:

e=3(2(#(STR))+1)

More generally, successive values of e can be derived as:

e=z(2(#(STR))+1)

where z is an odd integer ≧3, this value being fixed (that is, the same value is used for each successive calculation of e).

Another point to note regarding reducing vulnerability to cryptographic attacks is that the size of the message should, preferably, be similar to the value of the modulus n and this can be achieved by always adding an appropriate amount of random padding to the message content. Thus, for example, where the “message” is, in fact, a symmetric cryptographic key for encoding/decoding subsequent exchanges, the message can be padded by any suitable padding scheme such as OAEP (M. Bellare and P. Rogaway. Optimal Asymmetric Encryption—How to Encrypt with RSA. In Advances in Cryptology-Eurocrypt '94, pp. 92-111, Springer-Verlag, 1994).

With respect to the form of the blinding applied by the recipient B, in the described embodiments this has involved a modulo-n multiplication of the encrypted message by r^{e}, the blinding being subsequently cancelled by a modulo-n division of the message returned by the trusted authority by r^{(ed}^{_{U}}⁻¹). It will be appreciated by persons skilled in the art that the factor r^{e} mod n can be applied in other ways to blind the encrypted message. For example, the blinding operation can comprise a modulo-n division of the encrypted message by r^{e} (that is, a modulo-n multiplication by r^{-e}) with the blinding being subsequently cancelled by a modulo-n multiplication of the blinded decrypted message by r^{(1-ed}^{_{U}}⁾. It will also be appreciated that cancellation of the blinding operation following return of the partially-decrypted message from the trusted authority, can be effected before, jointly with, or after application of the recipient's decryption exponent component d_{U}. As regards the random number r, this should have a large value and should be generated by a cryptographically-strong random number generator. The blinding operation and its subsequent cancellation are totally transparent to the trusted authority.

As is generally the case with mediated RSA methods, in all the embodiments described herein, unless the trusted authority only serves one recipient B, the trusted authority will need to be provided with an identifier, generally a recipient identifier, in order to able to determine, by computation or look up, the correct value of d_{T} to use in carrying out its partial message decryption. Such a recipient identifier will typically be one of:

an identifier provided by the recipient B that presents the message to the trusted authority;

the value of the encryption exponent e used by the sender or the value of all or part of a string upon which that encryption exponent is based, in cases where a different respective said value is associated with each of multiple recipients;

the value of the modulus n used by the sender where a different respective said value is associated with each of multiple recipients.

Embodiments are possible in which the value of d_{U} is made the same for all recipients rather than being a recipient-specific secret. Thus, the FIG. 5 embodiment and its variants, the value of d_{U} can be made the same for all recipients and the appropriate value of d_{T} is calculated using this fixed value of d_{U}. The fixed value of d_{U} can, for example, be 1 so that the calculation of d_{T} becomes d_{T}=(d−1) mod φ; advantageously, where the STR passed to the trusted authority includes conditions to be checked (such as the identity of recipient B), the condition-checking process is arranged to output a value of 0 or 1 for fail or pass and this value is then subtracted (mod φ) from d to produce d_{T} whereby the correct value of d_{T} is only produced when the conditions specified in STR have been met (alternatively, if the output from the condition-checking process is 0, d_{T} is not determined). Making the value of d_{U} fixed for all recipients can also be done in respect of the embodiments of FIGS. 4 and 6. It will be appreciated that where the value of d_{U} is fixed, the trust authority can no longer rely on d_{U} to ensure that only the intended recipient can complete the decryption process; the trust authority should therefore check that the identity of the recipient requesting the partial decryption corresponds to that indicated either in the identity string STR (embodiments of FIGS. 4 and 5) or by a value of n indicated by the recipient requesting partial decryption (FIG. 6 embodiment and also usable for the FIG. 5 variant where the value of n is recipient dependent).

In certain situations it may be required that a message should only be decryptable with the cooperation of multiple trusted authorities. One way of doing this with mediated RSA methods is to sub-divide the decryption exponent component d_{T} into multiple sub-components each of which is held (or computable) by a respective trusted-authority entity (in effect, the trusted authority of the described embodiments is divided into multiple sub-authorities). In this case, the recipient B must go to each trusted-authority entity to get a message decrypted, each such entity applying its sub-component of d_{T} to the message to be decrypted.

For the identifier-based mediated RSA methods, another approach is possible and involves each trusted authority having its own associated public modulus n and private data. Consider, for example, the situation where the sender wishes to impose multiple conditions but no single trusted authority is competent to check all conditions—in this case, different trusted authorities can be used to check different conditions. In one implementation, the sender organizes the message content as a number of data sets (say k data sets) by using Shamir's secret sharing scheme and then encrypts each data set using an associated string STR (for example, specifying a respective condition to be checked) and the public modulus of a respective one of the trusted authorities; in order to retrieve the message, a recipient B has to go to all of the trusted authorities in order to decrypt all of the data sets because any k−1 data sets or less cannot disclose any of the message contents.

1. A mediated RSA cryptographic method in which a sender encrypts a message using an encryption exponent e and a public modulus n, and a recipient and a trusted authority cooperate with each other to decrypt the encrypted message by using respective components d_{U}, d_{T} of a decryption exponent; the recipient, on receiving the encrypted message, carrying out first processing comprising a modulo-n blinding operation using a factor r^{e} where r is a secret random number, the resultant processed message being passed to the trusted authority which effects second processing comprising applying its decryption exponent component d_{T} to the message, and the resultant further-processed message being returned to the recipient which effects third processing comprising both applying its decryption exponent component d_{U} and cancelling the blinding.

2. A cryptographic method according to claim 1, wherein:
the blinding operation comprises a modulo-n multiplication of the encrypted message by r^{e}; and
in said third processing the blinding is cancelled by a modulo-n multiplication of the blinded decrypted message by r^{(ed}^{_{U}}⁻¹⁾.

3. A cryptographic method according to claim 1, wherein:
the blinding operation comprises a modulo-n division of the encrypted message by r^{e}; and
in said third processing the blinding is cancelled by a modulo-n multiplication of the blinded decrypted message by r^{(1-ed}^{_{U}}⁾.

4. A cryptographic method according to claim 1, wherein the message comprises a content portion, random padding and a content length indicator.

5. A cryptographic method according to claim 1, wherein the blinded message is passed from the recipient to the trusted authority over a channel arranged to detect any modification of the blinded message.

6. A cryptographic method according to claim 1, wherein the trusted authority serves multiple recipients each of which has its own associated decryption exponent component d_{U}; the trusted authority being provided, in relation to a said message passed to it for processing, with a recipient identifier which the trusted authority uses to determine the appropriate decryption exponent component d_{T} for said second processing.

7. A cryptographic method according to claim 6, wherein said recipient identifier is one of:
an identifier provided by the recipient passing the message to the trusted authority;
the value of the encryption exponent e used by the sender or the value of all or part of a string upon which that encryption exponent is based, where a different respective said value is associated with each of said multiple recipients;
the value of the modulus n used by the sender where a different respective said value is associated with each of said multiple recipients.

8. A cryptographic method according to claim 1, wherein said encryption exponent e is a function of a string chosen by the sender.

9. A cryptographic method according to claim 8, wherein said function is such that e is odd, and wherein the public modulus n is the product of two distinct random primes:
p=(2p′+1)
q=(2q′+1)
where p′ and q′ are Sophie Germain primes, p and q being private to the trusted authority.

10. A cryptographic method according to claim 9, wherein said function is such that the values of e derived from different strings have a common divisor greater than one.

11. A cryptographic method according to claim 9, wherein said function takes the form:
e=z(2(#(sender-chosen string))+1)
where # is a hash function and z is an odd integer greater than or equal to 3, the same value of z being used for successive determinations of e.

12. A cryptographic method according to claim 9, wherein said function is a hash function where hash(sender-chosen string)≡3 mod 6.

13. A cryptographic method according to claim 1, wherein:
said encryption exponent e is a function of a string chosen by the sender, and
the trusted authority serves multiple recipients each of which has its own associated decryption exponent component d_{U};
the trusted authority being provided, in relation to a said message passed to it for processing, with a recipient identifier which the trusted authority uses to determine, for the string chosen by the sender, the appropriate decryption exponent component d_{T} to use for said second processing.

14. A cryptographic method according to claim 13, wherein:
the trusted authority stores the recipient decryption exponent components d_{U} of said multiple recipients;
the sender-chosen string used in forming the encryption exponent e for encrypting a said message, is passed to the trusted authority in association with the message; and
the trusted authority uses the said recipient identifier relating to the message to look up the corresponding recipient decryption exponent component d_{U} which it then uses, together with said string and private data associated with said modulus n, to compute the decryption exponent component d_{T} to be used in said second processing.

15. A cryptographic method according to claim 14, wherein the sender-chosen string comprises information concerning actions to be taken by the trusted authority, the trusted authority using the information in the string to carry out corresponding actions.

16. A cryptographic method according to claim 15, wherein said information specifies one or more conditions to be checked by the trusted authority, the trusted authority, in carrying out said second processing, checking said one or more conditions and only completing the second processing or only passing the resultant further-processed message to the recipient, if satisfied that said one or more conditions are met.

17. A cryptographic method according to claim 14, wherein the modulus n and the associated private data are specific to the trusted authority.

18. A cryptographic method according to claim 14, wherein the modulus n and the associated private data are specific to each of said multiple recipients and at least these private datas are stored by the trusted authority, the trusted authority further using the recipient identifier to look up the corresponding private data to be used in computing the decryption exponent component d_{T}.

19. A cryptographic method according to claim 13, wherein:
the string chosen by the sender is chosen from a set of predetermined strings;
the trusted authority stores both the recipient decryption exponent components d_{U} of said multiple recipients, and said set of predetermined strings;
an indicator of the sender-chosen string used in relation to said message is passed, in associated with the message, to the trusted authority, the trusted authority using this indicator to look up the corresponding stored string; and
the trusted authority uses the said recipient identifier relating to the message to look up the corresponding recipient decryption exponent component d_{U} which it then uses, together with the looked-up string and private data associated with said modulus n, to compute the decryption exponent component d_{T} to be used in said second processing.

20. A cryptographic method according to claim 19, wherein said set of predetermined strings comprises a respective string for each of said multiple recipients, said indicator of the sender-chosen string being formed by the recipient indicator.

21. A cryptographic method according to claim 20, wherein said information specifies one or more conditions to be checked by the trusted authority, the trusted authority, in carrying out said second processing, checking said one or more conditions and only completing the second processing or only passing the resultant further-processed message to the recipient, if satisfied that said one or more conditions are met.

22. A cryptographic method according to claim 19, wherein the trusted authority stores said set of predetermined strings and at least some of the strings comprise information concerning actions to be taken by the trusted authority, the trusted authority using this information where present in a said looked-up string to carry out corresponding actions.

23. A cryptographic method according to claim 19, wherein the modulus n and the associated private data are specific to the trusted authority.

24. A cryptographic method according to claim 19, wherein the modulus n and the associated private data are specific to each of said multiple recipients and at least these private datas are stored by the trusted authority, the trusted authority further using the recipient identifier to look up the corresponding private data to be used in computing the decryption exponent component d_{T}.

25. A cryptographic method according to claim 13, wherein the string chosen by the sender is chosen from a set of predetermined strings comprising a different string for each of said multiple recipients, the trusted authority storing its corresponding decryption exponent component d_{T} for each recipient; and the trusted authority using said recipient identifier relating to a message passed to it for processing to look up its corresponding decryption exponent component d_{T} to be used in said second processing.

26. A cryptographic method according to claim 25, wherein at least some of the strings comprise information concerning actions to be taken by the trusted authority, the trusted authority using the recipient identifier to look up the corresponding string and using said information, where present in a looked-up string, to carry out corresponding actions.

27. A cryptographic method according to claim 26, wherein said information specifies one or more conditions to be checked by the trusted authority, the trusted authority, in carrying out said second processing, checking said one or more conditions and only completing the second processing or only passing the resultant further-processed message to the recipient, if satisfied that said one or more conditions are met.

28. A cryptographic method according to claim 1, wherein:
said encryption exponent e is a function of a string chosen by the sender, and
the trusted authority serves multiple recipients with the value of the decryption exponent component d_{U} associated with each recipient being the same;
the trusted authority being provided, in relation to a said message passed to it for processing, with a recipient identifier, formed by all or part of said string, against which the trusted authority checks the identity of the recipient providing the message for processing; and, at least where this recipient-identity check is passed, the trusted authority using the string, the value of d_{U}, and private data associated with said modulus n, to compute the appropriate decryption exponent component d_{T} to use for said second processing.

29. A cryptographic method according to claim 15, wherein said string, in addition to including said recipient identifier, specifies one or more conditions to be checked by the trusted authority, the trusted authority, in carrying out said second processing, checking said one or more conditions and only completing the second processing or only passing the resultant further-processed message to the recipient, if satisfied that said one or more conditions are met.

30. A cryptographic method according to claim 28, wherein the modulus n and the associated private data are specific to the trusted authority.

31. A cryptographic method according to claim 28, wherein the modulus n and the associated private data are specific to each of said multiple recipients and at least these private datas are stored by the trusted authority, the trusted authority further using the recipient identifier to look up the corresponding private data to be used in computing the decryption exponent component d_{T}.

32. A cryptographic method according to claim 1, wherein:
said encryption exponent e is a function of a string chosen by the sender,
the trusted authority serves multiple recipients with the value of the decryption exponent component d_{U} associated with each recipient being the same, and
the modulus n, and associated private data known to the trusted authority, are specific to each of said multiple recipients and at least these private datas are stored by the trusted authority;
the trusted authority being provided, in relation to a said message passed to it for processing, with a recipient identifier, in the form of said modulus, against which the trusted authority checks the identity of the recipient providing the message for processing; and, at least where this recipient-identity check is passed, the trusted authority using the string, the value of d_{U}, and the private data associated with the modulus n provided as the recipient identifier, to compute the appropriate decryption exponent component d_{T} to use for said second processing.

33. A cryptographic method according to claim 32, wherein the sender-chosen string comprises information concerning actions to be taken by the trusted authority, the trusted authority using the information in the string to carry out corresponding actions.

34. A cryptographic method according to claim 33, wherein said information specifies one or more conditions to be checked by the trusted authority, the trusted authority, in carrying out said second processing, checking said one or more conditions and only completing the second processing or only passing the resultant further-processed message to the recipient, if satisfied that said one or more conditions are met.

35. A cryptographic method according to claim 1, wherein:
the trusted authority serves multiple recipients and said encryption exponent e is a function of a string chosen by the sender from a set of predetermined strings comprising a different string for each of said multiple recipients, and
the value of the decryption exponent component d_{U} associated with each recipient is the same;
the trusted authority being provided, in relation to a said message passed to it for processing, with a recipient identifier, formed by said string, against which the trusted authority checks the identity of the recipient providing the message for processing; and, at least where this recipient-identity check is passed, the trusted authority using the string to look up its corresponding decryption exponent component d_{T} to be used in said second processing.

36. A cryptographic method according to claim 1, wherein:
said encryption exponent e is fixed,
the trusted authority serves multiple recipients with the value of the modulus n being specific to each recipient, and
the value of the decryption exponent component d_{U} is specific to each said recipient and the trusted authority stores the corresponding decryption exponent component d_{T} for each recipient;
the trusted authority being provided, in relation to a said message passed to it for processing, with a recipient identifier and the trusted authority using the said recipient identifier to look up the corresponding decryption exponent component d_{T} to be used in said second processing.

37. A cryptographic method according to claim 16, wherein:
said encryption exponent e is fixed,
the trusted authority serves multiple recipients with the value of the modulus n, and of associated private data known to the trusted authority, being specific to each recipient, at least these private datas being stored by the trusted authority, and
the value of the decryption exponent component d_{U} is specific to each said recipient with these values being stored by the trusted authority;
the trusted authority being provided, in relation to a said message passed to it for processing, with a recipient identifier and the trusted authority using the said recipient identifier to look up the corresponding recipient decryption exponent component d_{U} and private data which it then uses, together with said encryption exponent, to compute the decryption exponent component d_{T} to be used in said second processing.

38. A cryptographic method according to claim 1, wherein:
said encryption exponent e is fixed,
the trusted authority serves multiple recipients with the value of the modulus n being specific to each recipient,
the value of the decryption exponent component d_{U} associated with each recipient is the same, and
the trusted authority stores the appropriate decryption exponent component d_{T} for each recipient;
the trusted authority being provided, in relation to a said message passed to it for processing, with a recipient identifier, in the form of said modulus n, against which the trusted authority checks the identity of the recipient providing the message for processing; and, at least where this recipient-identity check is passed, the trusted authority using the recipient identifier to look up the appropriate decryption exponent component d_{T} to use for said second processing.

39. A cryptographic method according to claim 1, wherein:
said encryption exponent e is fixed,
the trusted authority serves multiple recipients with the value of the modulus n, and of associated private data known to the trusted authority, being specific to each recipient, at least these private datas being stored by the trusted authority, and
the value of the decryption exponent component d_{U} associated with each recipient is the same;
the trusted authority being provided, in relation to a said message passed to it for processing, with a recipient identifier in the form of said modulus, against which the trusted authority checks the identity of the recipient providing the message for processing; and, at least where this recipient-identity check is passed, the trusted authority using the recipient identifier to look up the corresponding said private data which it then uses, together with said encryption exponent and the decryption exponent component d_{U} , to compute the decryption exponent component d_{T} to be used in said second processing.

40. A cryptographic system for carrying out the cryptographic method of claim 1.

41. Cryptographic apparatus for carrying out the operations effected by the recipient in the cryptographic method of claim 1.

42. A computer program product for conditioning programmable computing apparatus to carry out the operations effected by the recipient in the cryptographic method of claim 1.
